(19) United States
(12) Patent Application Publication
(10) Pub. No.: US 2020/0167825 A1
(43) Pub. Date: May 28, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/681,934

(22) Filed: Nov. 13, 2019

(30) Foreign Application Priority Data
Nov. 28, 2018 (JP) 2018-222810

(51) Int. Cl. G06Q 30/02; G06F 3/14; G09F 21/04

(52) U.S. Cl. CPC G06Q 30/0266; G09F 21/048; G06F 3/1454

(57) ABSTRACT

An information processing apparatus for outputting an advertisement using one or more vehicles each provided with an advertisement display unit on the outside includes a controller configured to execute the processing of organizing a file of vehicles including a plurality of vehicles on the basis of location information obtained from the vehicles, selecting an advertisement including a plurality of scenes with a prescribed order of display on the basis of the number of vehicles included in the file, and causing the advertisement displaying units of the plurality of vehicles included in the file to respectively display the plurality of scenes included in the advertisement.

### CROSS REFERENCE TO THE RELATED APPLICATION

This application claims the benefit of Japanese Patent Application No. 2018-222810, filed on Nov. 28, 2018, which is hereby incorporated by reference herein in its entirety.

### BACKGROUND

### Technical Field

The present disclosure relates to technologies of advertising using vehicles as media.

### Description of the Related Art

Advertising using vehicles as media has been developed in recent years. For example, Patent Literature 1 in the citation lest below discloses a system that causes a plurality of vehicles provided with display units on their outer surfaces to display an advertisement cooperatively. Displaying an advertisement by a plurality of vehicles in a cooperative manner can lead to an improvement in the effectiveness of advertising.

### CITATION LIST

### Patent Literature

Patent Literature 1: Japanese Patent Application Laid-Open No. 2013-089096

### SUMMARY

A problem encountered with systems that provide advertisements using vehicles as media is that vehicles that display advertisements cannot provide a large amount of information to pedestrians when they are travelling.

The present disclosure has been made to solve this problem, and an object of the present disclosure is to enhance the effectiveness of advertisements provided using vehicles as media.

According to a first aspect of the present disclosure, there is provided an information processing apparatus for outputting an advertisement using one or more vehicles each provided with an advertisement display unit on the outside, comprising a controller configured to execute the processing of organizing a file of vehicles including a plurality of vehicles on the basis of location information obtained from the vehicles, selecting an advertisement including a plurality of scenes with a prescribed order of display on the basis of the number of vehicles included in the file, and causing the advertisement displaying units of the plurality of vehicles included in the file to respectively display the plurality of scenes included in the advertisement.

According to a second aspect of the present disclosure, there is provided an information processing method for outputting an advertisement using one or more vehicles each provided with an advertisement display unit on the outside, comprising organizing a file of vehicles including a plurality of vehicles on the basis of location information obtained from the vehicles, selecting an advertisement including a plurality of scenes with a prescribed order of display on the basis of the number of vehicles included in the file, and causing the advertisement displaying units of the plurality of vehicles included in the file to respectively display the plurality of scenes included in the advertisement.

According to a third aspect of the present disclosure, there is provided a program that causes a computer to implement the above-described information processing method or a computer-readable storage medium in which such a program is stored in a non-transitory manner.

The present disclosure can enhance the effectiveness of advertisements provided using vehicles as media.

### BRIEF DESCRIPTION OF THE DRAWINGS

FIG. 1 is a diagram illustrating the general configuration of an advertisement distribution system according to an embodiment.

FIG. 2 is a diagram illustrating a file organized by a server apparatus 20.

FIG. 3 is a diagram illustrating a plurality of scenes included in an advertisement content.

FIG. 4 is a diagram illustrating relationship between scenes and a file of vehicles.

FIG. 5 is a diagram illustrating the system configuration of a vehicle 10 according to a first embodiment.

FIG. 6 is a diagram illustrating the positions of display units of vehicles 10.

FIG. 7 is a diagram illustrating the system configuration of the server apparatus 20 according to the first embodiment.

FIG. 8 shows an example of an advertisement information table stored in a database.

FIG. 9 shows an example of a vehicle information table stored in a database.

FIG. 10 shows an example of a travel record table stored in a database.

FIG. 11 is a flow chart of a process of sending information executed by the vehicle 10.

FIG. 12 is a flow chart of a process of collecting information executed by the server apparatus 20.

FIG. 13 is a flow chart of a process of distributing an advertisement executed by the server apparatus 20.

FIG. 14 is a flow chart of a process of stopping display of an advertisement executed by the server apparatus 20.

FIGS. 15A and 15B are diagrams each illustrating a change in the configuration of a file of vehicles.

### DESCRIPTION OF THE EMBODIMENTS

An advertisement distribution system according to the present disclosure includes a server apparatus and a plurality of vehicles. The server apparatus distributes advertisements to the plurality of vehicles, and each vehicle displays an advertisement content on its display apparatus that faces outward. Each vehicle in the system displays an advertisement content (in the form of a still or moving image) it has received from the server apparatus by an apparatus(es) provided on the outside of the vehicle body while it is travelling.

It is desirable for the system that uses moving vehicles as advertising media to distribute advertisements that are as easy as possible for the viewers to grasp. However, simplifying the content of advertising to this end can lead to deficient understanding by the viewers of messages that the advertiser wants to deliver.

The information processing apparatus according to the present disclosure is configured to organize a file of a plurality of vehicles on the basis of location information obtained from the vehicles. Moreover, the information processing apparatus selects an advertisement including a plurality of scenes with a prescribed order of display (namely, the order of display of the scenes is prescribed) on the basis of the number of vehicles included in the file and causes advertisement display units of the vehicles included in the file to display the respective scenes of the advertisement.

An example of the above-mentioned advertisement including a plurality of scenes with a prescribed order of display is an advertisement made up of a series of still (or moving) images that tell a story. The information processing apparatus organizes a file of a plurality of vehicles and then outputs a plurality of scenes with a prescribed order of display using advertisement display units of the vehicles included in the file. Thus, the information processing apparatus can employ vehicles to display the scenes of the advertisement to the same user (e.g. a pedestrian) in the order intended by the advertiser.

The controller according to the first aspect of the present disclosure may be configured to control the plurality of vehicles included in the file to cause them to output the plurality of scenes with a prescribed order of display in order from the front to rear of the file.

This allows users on a road to see the scenes of an advertisement in the prescribed order of display. Therefore, it is possible to provide a larger amount of information to them than in the case where the advertisement is displayed by only one vehicle.

The controller may be configured to reorganize the file when a change in the configuration of the organized file occurs.

The configuration of the file refers to, for example, the number of vehicles from the frontmost vehicle to the rearmost vehicle and the order of the vehicles. If a change, such as leaving of a vehicle from the file, entrance of another vehicle into the file, or a change in the order of vehicles in the file occurs, it is possible to adapt the mode of displaying an advertisement to continue displaying appropriately.

The controller may be configured to select an advertisement including scenes that are equal in number to the number of vehicles included in the file.

In the following, an embodiment of the present disclosure will be described with reference to the accompanying drawings. It should be understood that hardware configurations, module configurations, and functional configurations that will be described in the description of the embodiment are not intended to limit the technical scope of the present disclosure unless otherwise stated.

### First Embodiment

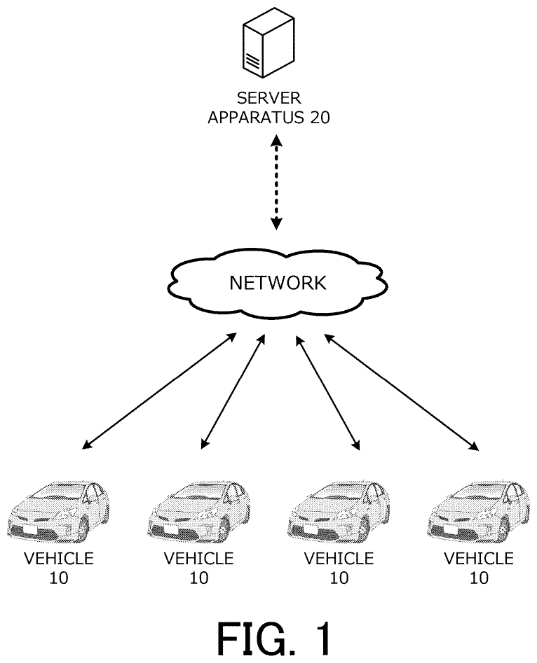

FIG. 1 is a diagram illustrating an exemplary system configuration of an advertisement distribution system according to a first embodiment. The advertisement distribution system illustrated in FIG. 1 is configured to group vehicles each having a plurality of display units provided on the outside of the vehicle body and display an advertisement content using the display units of the grouped vehicles. Examples of the advertisement content include still images, moving images (videos), and message information.

The general configuration of the advertisement distribution system according to the first embodiment is illustrated in FIG. 1. The advertisement distribution system according to the embodiment includes a plurality of vehicles 10 and a server apparatus 20.

While FIG. 1 shows one server apparatus 20 and four vehicles 10 by way of example, a plurality of server apparatuses 20 may be connected to a network. The number of vehicles connected to the network is not limited to that in the illustrative case in FIG. 1. In the following description, vehicles that can be connected to the network will be collectively referred to as vehicles 10.

The vehicles 10 and the server apparatus 20 in the advertisement distribution system according to the embodiment are interconnected by a network. The network may be a wide area network (WAN) or a global public network, such as the Internet, or other communication networks. The network may include a telephone communication network, such as a cellular phone network and a wireless communication network, such as WiFi (registered trademark).

The vehicle 10 is an automobile having a plurality of display units provided on its outside and capable of displaying an advertisement content received from the server apparatus 20. The expression “displaying an advertisement” in the description of the embodiment means outputting image data to a display unit to let it display a still or moving image. The display unit may be a liquid crystal display, an organic electro-luminescence display, an LED (Light Emitting Diode) matrix, or a projector. The vehicle 10 receives data of advertisement contents (or advertisement data) distributed by the server apparatus 20 and displays advertisement contents in the form of still images, slide shows, moving images (videos), and/or message information to the outside through its display units. The vehicle 10 periodically sends to the server apparatus 20 information relating to the state of travel (e.g. information about its location, speed, and direction of travel) and information relating to the status of display of an advertisement (e.g. the ID of an advertisement on display). In the following, the information relating to the state of travel will be referred to as “status information”, and the information relating to the status of display of an advertisement will be referred to as “advertisement display information”.

In the description of the embodiment, the term “users” will be used to refer to an intended audience of an advertisement output by the vehicles 10. Users may be, for example, pedestrians.

The server apparatus 20 is a server that manages the vehicles 10 and advertisement contents to be displayed by the vehicles 10. The server apparatus 20 has data relating to advertisement contents displayed by the vehicles 10 and data about the vehicles 10 provided with display units. The server apparatus 20 determines advertisement contents to be distributed to the vehicles 10 and distributes advertisement contents to the vehicles 10. Moreover, the server apparatus 20 manages the locations of travelling vehicles 10, records of travel of the vehicles 10, and identification data of the advertisements displayed by the vehicles 10.

The server apparatus 20 according to the embodiment picks up a plurality of vehicles 10 located close to each other within a certain range to organize a file, based on location information received from the vehicles 10. In this specification, the term “file” is used to refer to a group of a plurality of vehicles 10 travelling one behind another. The server apparatus 20 sends to the vehicles 10 included in the file organized as above an advertisement content that can be displayed by the display units of the vehicles 10 in a cooperative manner.

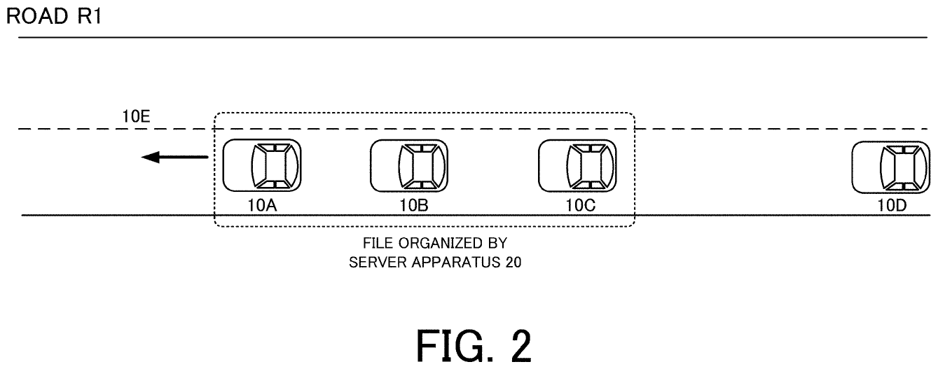

FIG. 2 illustrates formation of a file. In FIG. 2, vehicles 10A to 10C are travelling a road R1 in the direction indicated by the arrow. The road R1 is a two-lane road having two lanes of opposite directions of travel separated by a center line. The server apparatus 20 picks up a plurality of vehicles (vehicles 10A to 10C) that are supposed to be travelling or at standstill one behind another within a certain range, based on location information received from the vehicles. For example, the server apparatus 20 picks up a vehicle 10B and vehicles 10A and 10C respectively ahead of and behind the vehicle 10B within a certain range (e.g. within 10 meters). While three vehicles will be described by way of example, the number of vehicles to be grouped is not limited to three.

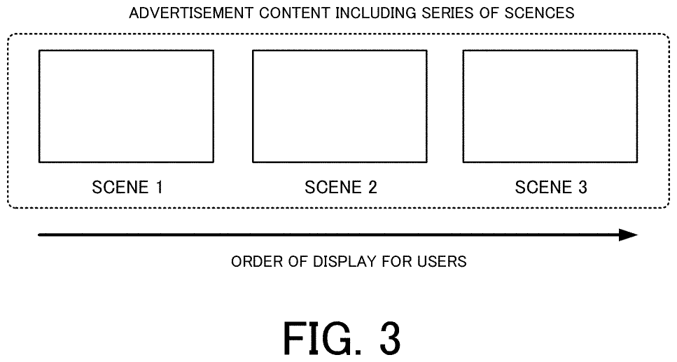

FIG. 3 illustrates an advertisement content to be displayed by display units of the vehicles 10 included in a file. In the case illustrated in FIG. 3, the advertisement content includes three scenes. This advertisement content has a prescribed order of displaying the scenes for users. Specifically, it is prescribed that the images be displayed in the order of scene 1, scene 2, and scene 3. While the advertisement content includes three scenes in this illustrative case, the number of scenes included in an advertisement content is not limited to three.

The server apparatus 20 according to the embodiment selects an advertisement content suitable for the file organized as above from among advertisement contents including multiple scenes and sends the selected advertisement content to the vehicles 10 included in the file. The advertisement content thus sent includes information designating which scenes are to be displayed by the respective vehicles 10 in the file. This information will be hereinafter referred to as “output information”.

After receiving the advertisement content, each vehicle 10 determines the scene to be output by it on the basis of the output information associated with the advertisement content and its position in the file and outputs a still image, a moving image, or a message corresponding to the scene.

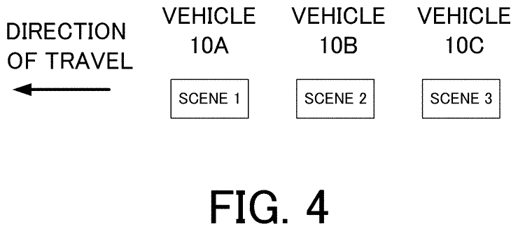

FIG. 4 is a diagram illustrating the scenes to be output by the vehicles. In this illustrative case, the server apparatus creates output information that causes the frontmost (or leading) vehicle 10A in the file to display scene 1, the second vehicle 10B to display scene 2, and the rearmost vehicle 10C to display scene 3, and the vehicles 10A, 10B, and 10C output the advertisement content according to the output information. The advertisement system according to the first embodiment as above can strongly impress consumers who see the advertisement content and enhance the advertising effectiveness.

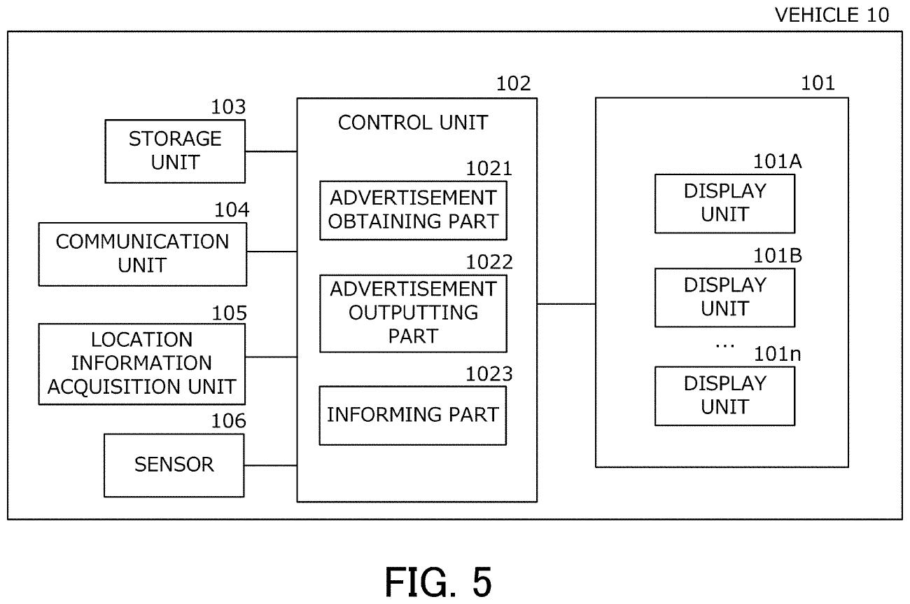

Next, the configuration of the vehicle 10 will be described with reference to FIG. 5, which is a diagram illustrating the system configuration of the vehicle 10.

The vehicle 10 has a display apparatus 101, a control unit 102, a storage unit 103, a communication unit 104, a location information acquisition unit 105, and a sensor 106.

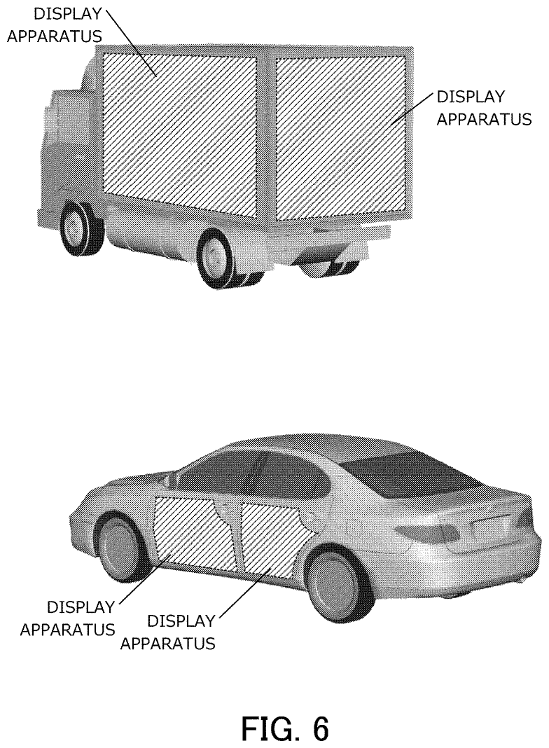

The display apparatus 101 includes a plurality of display units provided on the outside of the vehicle 10. As illustrated in FIG. 6, the vehicle 10 according to the embodiment has a plurality of display units (101A, 101B, . . . , 101n) that face outward. The display units will be collectively designated as the display units 101, where identification of individual display units is not necessary.

The display unit 101 may be a liquid crystal display, an organic electro-luminescence display, an LED matrix, or a projector.

The number of the display units provided on a vehicle 10 may vary among different types or models of vehicles 10. The display units may be provided on different positions on the vehicle, for example, on the left side, the right side, the rear, and the top of the vehicle 10. For example, a truck may have three display units provided on the left side, the right side, and the rear of its body. A sedan may have four display units provided on the front door on the left side, the rear door on the left side, the front door on the right side, and the rear door on the right side. Display units 101 may be provided at positions other than those described above. For example, if it is possible to project images on a glass plate, display units may be provided on window panes (e.g. side windows and/or rear window).

The control unit 102 is a computing device that controls the function of outputting advertisements among the functions of the vehicle 10. The control unit 102 may be implemented by a computational processing unit, such as a CPU (Central Processing Unit).

The control unit 102 includes three functional modules, which include an advertisement obtaining part 1021, an advertisement outputting part 1022, and an informing part 1023. These functional modules may be implemented by executing programs stored in the storage unit 103 (described later) by a CPU.

The advertisement obtaining part 1021 obtains data (advertisement data) relating to an advertisement content to be output to the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an image or the like contained in the advertisement data to the display apparatus 101. A condition for outputting the advertisement content may be specified in the advertisement data, and the advertisement may be output only when the condition is met. The advertisement data may designate the position and the size of the display unit to be used, and the advertisement outputting part 1022 may output the advertisement according to the designations.

Advertisement data used in the system according to the embodiment includes a plurality of scenes, and the associated output information designates which vehicles are to output which scenes by their positions in the file. Therefore, the advertisement outputting part 1022 of each vehicle 10 consults the output information to output an appropriate scene of the advertisement content.

The informing part 1023 sends information relating to the state of travel of the vehicle 10 to the server apparatus 20. Specifically, the informing part 1023 collects the status information and the advertisement display information described above and sends them to the server apparatus 20.

Details of processing executed by the above-described modules will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE etc.

The location information acquisition unit 105 is a unit configured to acquire location information of the vehicle 10. The location information acquisition unit 105 includes, for example, a GPS module and acquires location information (e.g. latitude and longitude) of the vehicle 10.

The sensor 106 refers to a group of sensors provided on the vehicle 10. The sensor 106 may include one or more sensors that acquire a physical quantity relating to the speed or average speed as sensor data. Examples of such sensors include a vehicle speed sensor and a distance sensor. Sensor data output from the sensor 106 is sent to the informing part 1023 and used to create status information. The sensor 106 is not necessarily one that measures a physical quantity. For example, the sensor 106 may obtain data relating to the degree of traffic congestion in the vicinity of the vehicle 10, data of the speeds of other vehicles present around the vehicle 10, and/or data relating to control of traffic signals, by road-to-vehicle communication or inter-vehicle communication. In the description of this embodiment, such data will also be referred to as sensor data.

FIG. 5 is given only to illustrate an exemplary configuration, and all or some of the functions shown in FIG. 5 may be implemented by circuits dedicated to the functions. Main and auxiliary storage devices other than those illustrated may be employed in combination to store and/or execute programs.

Next, the configuration of the server apparatus 20 will be described.

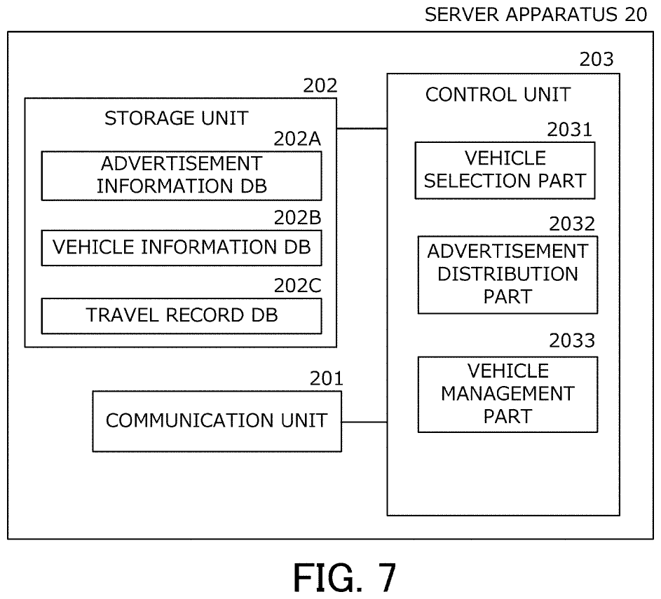

FIG. 7 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record database 202C.

The advertisement information database 202A is a database in which data relating to advertisements to be distributed to the vehicles 10 is stored. Such data is created by an advertiser(s).

The vehicle information database 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information (status information and advertisement display information) collected from the vehicles 10.

These databases are created by managing data stored in the storage unit by a database management system program (DBMS program) executed by the processor. The databases used in the system according to the embodiment are, for example, relational databases.

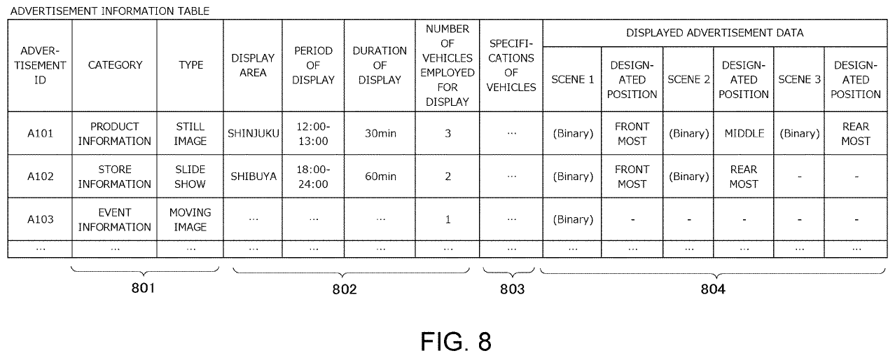

Data stored in the advertisement information database 202A will now be described with reference to FIG. 8. FIG. 8 illustrates an example of the content of an advertisement information table stored in the advertisement information database 202A. As illustrated, the information stored in the advertisement information table includes identification data of the advertisement (advertisement ID), information relating to properties of the advertisement (801), information relating to conditions for display of the advertisement (802), information designating vehicles to be employed to display the advertisement (803), and data to be output to the display units 101 of the vehicles (displayed advertisement data 804).

The displayed advertisement data may be, for example, still image data, data of consecutive images, or moving image data. The displayed advertisement data used in the system according to the embodiment includes a plurality of scenes. Although the maximum number of scenes is three in the illustrative case described here, the number of scene is not limited to this.

Each record stored in the advertisement information database 202A will be referred to as “advertisement data” hereinafter.

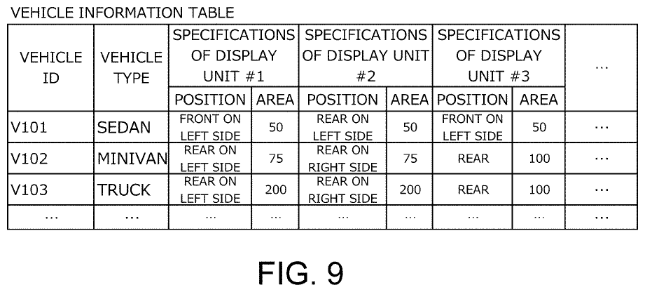

Next, data stored in the vehicle information database 202B will be described with reference to FIG. 9. FIG. 9 illustrates an example of the content of a vehicle information table stored in the vehicle information database 202B. The information stored in the vehicle information table includes information about the type of the vehicle and information about the display units. Examples of the information about the display units include, but are not limited to, the number of display units, the positions at which the display apparatuses are provided, and the display areas.

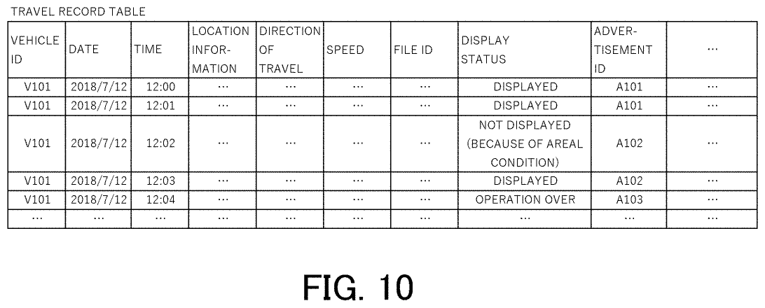

Data stored in the travel record database 202C will be described with reference to FIG. 10. FIG. 10 illustrates an example of the content of a travel record table stored in the travel record database 202C. Information stored in the travel record table includes identification data of the vehicle (vehicle ID), date and time, location information (e.g. latitude and longitude) of the vehicle 10, information about the direction of travel, identification data of a file that has been organized (file ID), the status of display of advertisement, identification data of the advertisement displayed at the time (advertisement ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules a vehicle selection part 2031, an advertisement distribution part 2032, and a vehicle management part 2033. These three functional modules may be implemented by executing programs stored in auxiliary storage by the CPU.

The vehicle selection part 2031 picks up a plurality of vehicles to organize a file based on certain conditions. For example, the vehicle selection part 2031 organizes a file based on status information (e.g. location information and information about the direction of travel) collected from the vehicles and information about the properties of the vehicles. The status information collected from the vehicles can be retrieved from the travel record database 202C, and information about the properties of the vehicles can be retrieved from the vehicle information database 202B.

The advertisement distribution part 2032 determines an advertisement to be displayed by one or more vehicles 10 included in the file organized as above and sends the advertisement data to all the vehicles 10 included in the file. The vehicle management part 2033 communicates with the vehicles 10 periodically to collect status information and advertisement display information and updates the travel record database 202C.

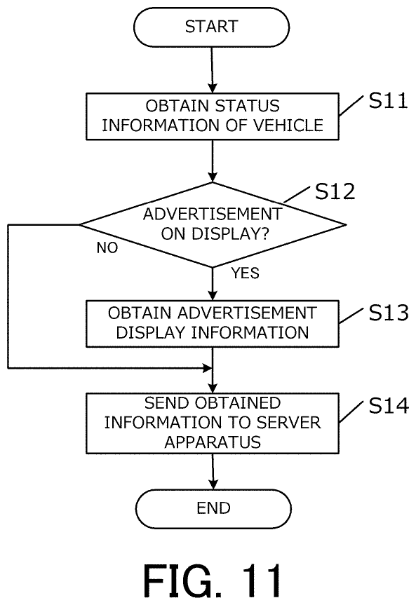

Next, a process of distributing an advertisement to the vehicles 10 and displaying the advertisement performed by the advertisement distribution system according to the embodiment will be described. FIG. 11 is a flow chart of a process performed by each vehicle (specifically, the informing part 1023 thereof). The process according to the flow chart of FIG. 11 is executed periodically (or every unit time) by each of the vehicles 10 under management of the server apparatus 20.

Firstly in step S11, the vehicle 10 obtains status information, namely information about the state of the vehicle 10. Specifically, for example, the vehicle 10 obtains location information and information about the speed and direction of travel by the location information acquisition unit 105 and the sensor 106. The vehicle 10 temporarily stores the information thus obtained with time information associated with it in a certain area of the storage unit 103, and then the process proceeds to step S12. The vehicle 10 may obtain data of the degree of traffic congestion in the vicinity of the vehicle 10, data relating to the speed of other vehicles around the vehicle 10 (specifically, the speed of other vehicles 10 that are travelling ahead or behind and their vehicle IDs) by road-to-vehicle communication and/or inter-vehicle communication and add such data to the status information.

In step S12, the vehicle 10 determines whether it is presently displaying an advertisement. For example, if an advertisement is being displayed based on information received from the server apparatus 20, an affirmative determination is made in this step.

In step S13, the vehicle 10 obtains advertisement display information, which includes, for example, information about the presence/absence of displayed advertisement (with its ID, if present), information about the status of display of advertisement, and the file ID of the file in which the vehicle 10 is included. The vehicle 10 temporarily stores the information thus obtained with time information associated with it in a certain area of the storage unit 103, and then the process proceeds to step S14.

In step S14, the vehicle 10 sends to the server apparatus 20 the information obtained in steps S11 and S13 with the vehicle ID assigned to the vehicle 10 associated with it.

By executing the above process, the vehicle 10 can send information about the state of travel of it to the server apparatus 20. When the vehicle 10 has already been displaying an advertisement content, the vehicle 10 can send advertisement display information (including the file ID, the advertisement ID, and the status of display of the advertisement etc.) to the server apparatus 20.

The server apparatus 20 in the system according to the embodiment periodically sends an inquiry to the vehicles 10. Alternatively, each vehicle 10 may periodically send the aforementioned information to the server apparatus 20 by push communication.

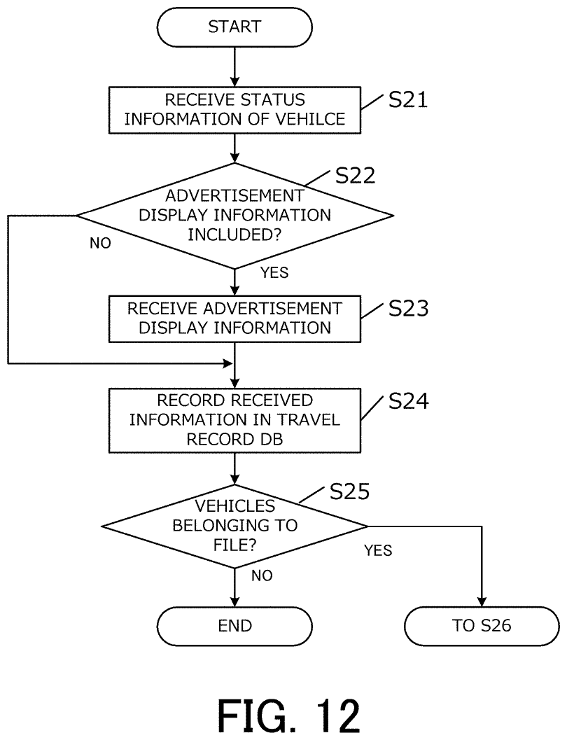

Next, a process performed by the server apparatus 20 according to the first embodiment will be described with reference to FIG. 12. FIG. 12 is a flow chart of a process executed by the server apparatus 20 to receive status information and advertisement display information sent from a vehicle 10 and record them in the database. The process according to the flow chart of FIG. 12 is executed periodically by the server apparatus 20 (specifically, the vehicle management part 2033 thereof).

Firstly in step S21, the server apparatus 20 receives status information sent from a vehicle 10. Specifically, the server apparatus 20 receives the vehicle ID and the status information associated with it. The server apparatus 20 temporarily stores the received status information in a certain area of the storage unit 202, and the process proceeds to step S22.

Then, in step S22, the server apparatus determines whether or not advertisement display information has been sent from the vehicle 10. If advertisement display information is included in the information sent from the vehicle, the process proceeds to step S23. If advertisement display information is not included in the information sent from the vehicle 10, the process proceeds to step S24.

In step S23, the server apparatus 20 receives the advertisement display information.

In step S24, the server apparatus 20 updates the travel record database 202C using the received information. Specifically, the server apparatus 20 creates a new record and records the information received in steps S21 and S23 in this record.

In step S25, the serer apparatus 20 determines whether or not there are vehicles 10 that are belonging to a file and displaying an advertisement. If an affirmative determination is made, the process proceeds to step S26. The processing of step S26 onward will be described later after description of organization of a file.

By executing the above process, the server apparatus 20 can update the travel record database 202C using information received from the vehicles 10. Specifically, the server apparatus 20 records the state of travel (e.g. location information and information about the speed and direction of travel) and advertisement display information (e.g. the display status and the advertisement ID of the advertisement on display) of the relevant vehicles. If a vehicle is belonging to a file and displaying an advertisement, the ID of the file is also recorded.

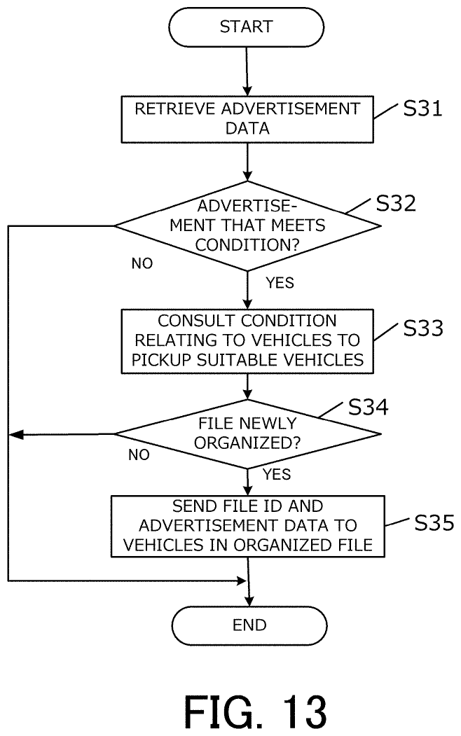

Next, the process of distributing an advertisement to vehicles 10 will be described with reference to FIG. 13.

FIG. 13 is a flow chart of the process of grouping a plurality of vehicles 10 that meet a certain condition to organize a file and sending advertisement data to the vehicles 10 in the file. The process according to the flow chart of FIG. 13 is executed periodically by the server apparatus 20.

Firstly in step S31, the advertisement distribution part 2032 retrieves data of advertisements (advertisement data) stored in the advertisement information database 202A. Then, in step S32, the advertisement distribution part 2032 determines whether or not data of an advertisement that meets a certain condition is included in the retrieved advertisement data. For example, if there is an advertisement whose designated display time meets the present date and time, an affirmative determination is made in step S32. If there is an advertisement that meets the condition, the advertisement distribution part 2032 extracts the corresponding advertisement data and temporarily stores it in a certain area of the storage unit 202.

Then, in step S33, the advertisement distribution part 2032 consults the vehicle information database 202B to pick up vehicles that are suitable for the extracted advertisement. In this step, the advertisement distribution part 2032 picks up vehicles that meet conditions specified in the advertisement data (e.g. the vehicle type, the position and area of display units, and the travelling area). Moreover, the advertisement distribution part obtains location information and information about the speed and direction of travel of the relevant vehicles.

Then, in step S34, the advertisement distribution part 2032 determines whether or not there are vehicles that can newly form a file in the vehicles picked up in step S33 and organizes a file if there are such vehicles.

Organization of a file may be carried out by the following process.

Firstly, the advertisement distribution part 2032 consults the travel record database 202C to pick up vehicles 10 that have not been assigned with a file ID from among the vehicles picked up in step S33.

Then, the server apparatus 20 organizes a file of vehicles that meets a condition for cooperative display of the advertisement content. For example, the server apparatus 20 picks up such vehicles that are located at locations (indicated by the location information) within a certain range and travelling in the same direction with differences in their speeds smaller than a certain value (e.g. ±2 km/h). The aforementioned certain range is determined dynamically according to the travelling speed of relevant vehicles. For example, if the travelling speed is approximately 40 km/h, vehicles located within the range of 80 meters may be picked up. If the travelling speed is lower than 10 km/h, due to a traffic jam, red signal or other reasons, vehicles located within the range of 40 meters may be picked up.

In organizing a file, the server apparatus 20 may consult map information. The server apparatus 20 assigns an identifier (i.e. file ID) to the file thus organized and temporarily stores it with associated information about the file in a certain area of the storage unit 202.

If a file is organized in the processing of step S34, the server apparatus 20 notifies the vehicles 10 included in the file of the file ID and sends the corresponding advertisement data to them in step S35. In cases where there are a plurality of advertisements that can be sent, an advertisement to be sent may be selected based on the number of vehicles in the file. For example, if the number of vehicles in the file is n, it is desirable that an advertisement including scenes that are equal or smaller in number to/than n be selected. An advertisement including scenes that are equal in number to the number of vehicles may be selected preferentially.

When sending the file ID in this step, the server apparatus 20 may also send to each vehicle 10 information about its position (or order from the top) in the file.

Each vehicle 10 in the file receives the file ID assigned thereto and the advertisement data sent from the server apparatus 20. The advertisement data includes information indicating which vehicles in the file are to display which scenes (804 in FIG. 8).

The control unit 102 of each vehicle 10 determines the scene to be output based on this information and the information received from the server apparatus 20 and outputs the advertisement content corresponding to this scene to the display apparatus 101. When the advertisement data includes a designation of the display unit to be used (e.g. a designation to the effect that the display unit on the roof should be used), all the vehicles 10 in the file use the designated display unit.

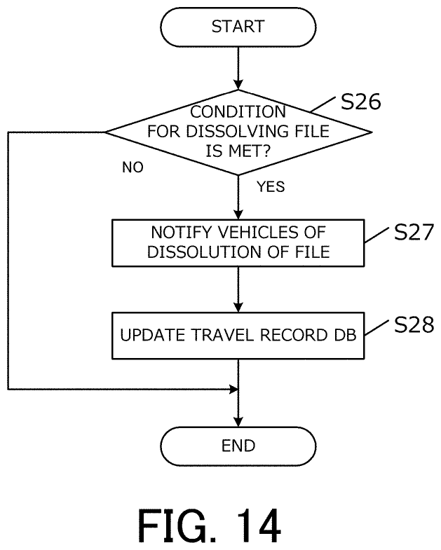

Next, we will described a process performed in the case where an affirmative determination is made in step S25 in the process according to the flow chart of FIG. 12, namely, in the case where there are vehicles 10 that are displaying an advertisement in a file. FIG. 14 is a flow chart of a process performed in the case where an affirmative determination is made in step S25.

In step S26 in this process, it is determined whether or not there is a file that meets a condition for dissolving the file (or a condition for stopping displaying the advertisement) among one or more files presently formed. It is determined that the condition for dissolving a file is met if the area in which the vehicles 10 in the file are travelling is outside the area designated by the advertisement data, if the present time falls out of the display time, if the display time has elapsed, or if the condition for forming a file is invalidated. The condition for forming a file may be invalidated when one or more vehicles 10 leave the file, when another vehicle enters between vehicles 10 in the file, or when the distance between vehicles 10 in the file exceeds a prescribed distance.

Dissolution of a file will now be described.

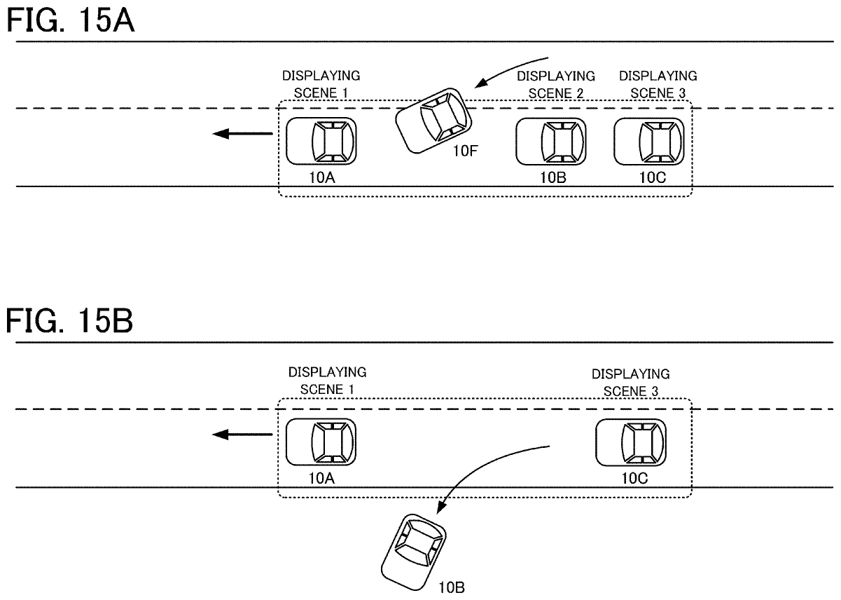

FIGS. 15A and 15B each illustrate a change in the configuration of a file of grouped vehicles. Areas indicated by dotted lines in FIGS. 15A and 15B indicate files of grouped vehicles. It is assumed that the vehicles in each file are travelling a road while displaying an advertisement content distributed to them in a cooperative manner.

There may be a case where another vehicle enters between vehicles that are forming a file. FIG. 15A illustrates a case where a vehicle 10F makes a lane change to enter between vehicles 10A and 10B belonging to a file of grouped vehicles. The integral display of the advertisement content that has been provided by the file of vehicles is interrupted at the location of entrance of the other vehicle (between the vehicle 10A and the vehicle 10B) to lose the unity.

There may also be a case where one (or some) of the vehicles 10 belonging to a file of grouped vehicles changes the direction or speed of travel to leave the group. FIG. 15B illustrates a case where one vehicle 10B in a file of grouped vehicles leaves the road to visit a facility or store. In the case illustrated in FIG. 15B also, the integral display of the advertisement content that has been provided by the file of grouped vehicles (vehicles 10A to 10C) breaks to lose the unity.

The advertisement distribution system according to the embodiment is configured to detect a change in the circumstances of a file of grouped vehicles with the lapse of time and determine dissolution of the file. The vehicles belonging to the file that is determined to be dissolved are notified of the dissolution of the group.

In step S27, the server apparatus 20 notifies the vehicles 10 included in the file of dissolution of the file and termination of display of the advertisement. Consequently, display of the advertisement by the vehicles 10 is ended. Moreover, in step S28, the server apparatus 20 updates the travel record database 202C and deletes the file ID.

After the file is dissolved, each of the vehicles in the file is regarded as not belonging to any file, and display of the advertisement by the vehicle is stopped. As above, it is possible to stop display of the advertisement when the formation of vehicles in the file changes.

Even when the file is dissolved, if the remaining vehicles meet the condition for forming a file, they may be grouped again by the above-described process. For example, if one vehicle in a file composed of four vehicles leaves the file, the advertisement output by the file may be changed from one including four scenes to one including three scenes. In this way, it is possible to display an advertisement suitable for the circumstances again. If a vehicle having no display unit enters between vehicles in a file, the file may be divided into two files so that they can display different contents repspectively. If the order of the vehicles in a file changes, the system according to the embodiment can maintain the order of display of scenes.

As described above, the system according to the first embodiment can group a plurality of vehicles 10 based on information sent from the vehicles 10 and cause the vehicles 10 in the group to display scenes of an advertisement in a prescribed order by their display units. The advertisement distribution system according to the first embodiment can cause a plurality of vehicles 10 in a file to display a plurality of scenes with a prescribed order of display in order from the frontmost vehicle. This can give a strong impression to those who see it (or consumers), leading to an enhancement of the effectiveness of the advertisement.

### Other Modifications

The processing and units that have been described in the foregoing may be employed in any combinations so long as it is technically feasible to do so.

A process described to be performed by one apparatus may be performed by a plurality of apparatuses in a distributed manner. A process described to be performed by different apparatuses may be performed by a single apparatus. The hardware configuration (server configuration) employed to implement various functions in a computer system may be modified flexibly.

The present disclosure can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus for outputting an advertisement using one or more vehicles each provided with an advertisement display unit on the outside, comprising a controller configured to execute the processing of:
organizing a file of vehicles including a plurality of vehicles on the basis of location information obtained from the vehicles;
selecting an advertisement including a plurality of scenes with a prescribed order of display on the basis of the number of vehicles included in the file; and
causing the advertisement displaying units of the plurality of vehicles included in the file to respectively display the plurality of scenes included in the advertisement.

2. An information processing apparatus according to claim 1, wherein
the controller is configured to control the plurality of vehicles included in the file to cause them to output the plurality of scenes with a prescribed order of display in order from the front to rear of the file.

3. An information processing apparatus according to claim 1, wherein
the controller is configured to reorganize the file when a change in the configuration of the organized file occurs.

4. An information processing apparatus according to claim 1, wherein
the controller is configured to select an advertisement including scenes that are equal in number to the number of vehicles included in the file.

5. An information processing method for outputting an advertisement using one or more vehicles each provided with an advertisement display unit on the outside, comprising:
organizing a file of vehicles including a plurality of vehicles on the basis of location information obtained from the vehicles;
selecting an advertisement including a plurality of scenes with a prescribed order of display on the basis of the number of vehicles included in the file; and
causing the advertisement displaying units of the plurality of vehicles included in the file to respectively display the plurality of scenes included in the advertisement.

6. A non-transitory computer readable storing medium recording a computer program for causing an information processing apparatus for outputting an advertisement using one or more vehicles each provided with an advertisement display unit on the outside to perform a method comprising the steps of:
organizing a file of vehicles including a plurality of vehicles on the basis of location information obtained from the vehicles;
selecting an advertisement including a plurality of scenes with a prescribed order of display on the basis of the number of vehicles included in the file; and
causing the advertisement displaying units of the plurality of vehicles included in the file to respectively display the plurality of scenes included in the advertisement.
